(19) United States
(12) Patent Application Publication
(10) Pub. No.: US 2018/0245621 A1
(43) Pub. Date: Aug. 30, 2018

(54) WASHERS FOR OVER-TIGHTENING PREVENTION OR MITIGATION

(71) Applicant: Philip Bogrash, Ashdod (IL)

(72) Inventor: Philip Bogrash, Ashdod (IL)

(21) Appl. No.: 15/753,819

(22) PCT Filed: Aug. 21, 2016
(86) PCT No.: PCT/IL16/50913

§ 371 Date: Feb. 20, 2018

(51) Int. Cl. F16B 39/284; F16B 39/26; F16B 31/02; F16B 31/06

(52) U.S. Cl. CPC F16B 39/284; F16B 31/06; F16B 31/028; F16B 39/26

(57) ABSTRACT

A lock-washer of conical, annular or other shapes capable of elastic flattening when the threaded connection, of which it is a part, is tightened and having tabs along the perimeter of the central hole. For most embodiments the tabs' tips form a circle of a diameter slightly larger than that of a threaded part which is to pass through the central hole. When during tightening the axial force acting on the lock-washer reaches a pre-determined level and the lock-washer flattens, its central hole diameter decreases and the tab tips enter the thread channel, which will cause the thread to jam, thus preventing further tightening, thereby limiting the axial load in the threaded connection to a pre-determined level. Another embodiment provides a lock-washer which compresses and expands radially during tightening providing a visual and/or audible signal for the worker when said expansion and a corresponding axial load reach the designated level.

This Patent Application claims the benefit of U.S. Provisional Patent Application 62/208,075 filed on Aug. 21, 2015. The present patent application is also related pursuant to the doctrine of unity of an invention to our U.S. Provisional Patent Applications 62/279,924 and 62/310,690 and 62/366,374

### FIELD OF THE INVENTION

This invention relates to washers and particularly to washers and lock-washers which can be used to limit tightening in a threaded connection to a pre-determined level, including washers attached to the nut or to an item being held by a threaded connection, and washers which can be used to decrease the tightening level for ease of unscrewing a threaded connection.

### 1. DESCRIPTION OF THE PRIOR ART

At the present time there is a variety of lock-washers which when compressed in a threaded connection generally deform spring-like and continue to exert pressure on both parts of the said connection thereby increasing friction between the threaded parts such as a nut and a bolt thus preventing their moving freely relative to each other and the loosening and unscrewing of the threaded connection due to vibration and impacts. The U.S. Pat. Nos. 4,257,467; 5,681,136 and 8,186,919 present examples of the prior art related to lock-washers and aim to improve respectively in the same order: the locking action, locking action, safety, resistance to corrosion, re-usability, the ease of unscrewing. However none of the known lock-washers have the ability to limit the axial load in a threaded connection to a pre-determined level. That causes a number of very common problems due to over-tightening; such as thread damage and leveling, shape distortion and fissure formation in the objects where threaded connections are used, especially where such objects are made of less strong or fragile materials such as aluminum or copper alloys or plastics. In many applications such as hand-held power tools where the self-tightening threaded connections are used to mount the abrasive disks, circular saws etc, the over-tightening quite often becomes so extreme, as to make it impossible for the said connections to be unscrewed in the field and requiring these power tools to be sent to a repair facility. In the precision assembly work often the wrenches whether manual, pneumatic or electric with torque indicators and/or limiters are used whereas the purpose of that is usually to limit the axial load in a threaded connection by limiting the torque applied when the said connection is tightened. Said wrenches are relatively expensive, require servicing and calibrations and frequently are unavailable in a given location. Also the possibility of over-tightening and damaging the items joined by a threaded connection limits the use of power tools when assembling or repairing objects made of non-ferrous alloys, wood or plastics thus adversely affecting productivity. Furthermore unnecessarily over-tightening the threaded connections makes them harder to unscrew. The lug nuts on vehicle wheels are routinely overtightened to such an extent that removing them on the road to replace a tire is a challenge for most drivers. There is also an ever-present possibility of not tightening a threaded connection strongly enough which leads to the possibility of that connection becoming loose or coming undone. In light of the above the ability to set or limit the axial load in a threaded connection to a pre-determined optimum level is therefore highly desirable. Furthermore oftentimes the locking action of the known lock-washers is proving inadequate and additional means need to be used to prevent the threaded connections from loosening.

### 2. OBJECTS AND ADVANTAGES

One object of the present invention is to prevent a threaded connection from being over-tightened and the thread damaged or leveled, without using the tools with torque indicators or limiters.

Another object is to make possible to set the axial load in a given threaded connection when it is being tightened to a pre-determined level to avoid the possibility of under-tightening or the distortions of shape and the fissure formation because of over-tightening in the objects being joined by the threaded connection without using the tools with torque indicators or limiters.

Another object is to prevent the over-tightening in self-tightening threaded connections in power tools and other self-tightening applications, which makes it difficult to replace the active parts like abrasive disks or circular saws.

Another object is to substantially improve the locking action of the lock-washer compared to prior art lock-washers.

Another object is to be able to decrease or eliminate the axial force in a highly tightened or stuck or rusted threaded connection without unscrewing the nut for easier disassembling said threaded connection afterwards.

### 3. BRIEF DESCRIPTION OF THE DRAWINGS

FIG. 1 is the frontal view of the cupped lock-washer with turnable tabs.

FIG. 2 is the cross-sectional view of said cupped lock-washer.

FIG. 3 shows a ring shaped lock-washer with a cross-sectionally arched circular section.

FIG. 4 shows a cross-sectional view of ring shaped lock-washer made of elastic material with tabs bearing annular metal insert.

FIG. 5 shows a ring-shaped lock-washer featuring a compressible ring with metal base having tabs along its central hole.

FIG. 5A shows a ring-shaped lock-washer whose metal base has tabs and elastic element consisting of wave spring

FIG. 6 shows a side view of a cupped lock-washer with wire inserts.

FIG. 7 is the view of the lock-washer shown in FIG. 6 from above.

FIG. 7A is a top view of a version of a tab

FIG. 8 is the view from the top of a different version of an annular lock-washer with metal base and annular compressible elastic element.

FIG. 9 shows an annular lock-washer with compressible elastic elements being an integral part of it.

FIG. 10 shows an annular lock-washer with bend-back tabs along the outer perimeter.

FIG. 11 shows a lock-washer with an indicator strip along its outer perimeter.

FIG. 12 shows a lock-washer featuring the transparent compressible ring over a layer of piezo-luminescent material.

FIG. 13 is a top view of a container washer.

FIG. 14 is a side view of an expandable radially washer with concentric folds.

FIG. 15 is a spiral disc washer—top view

FIG. 16 is a spiral disc washer with metal covers on top and bottom—side view

FIG. 17 stopper washer for power tool overtightening prevention

FIG. 18 washer attached to abrasive disc.

FIG. 19 washer mounted on power tool spindle nut.

FIG. 20 is a top view of incomplete coil stopper washer for power tool overtightening prevention

FIG. 21 is a side view of incomplete coil stopper washer for power tool overtightening prevention

### 4. DESCRIPTION

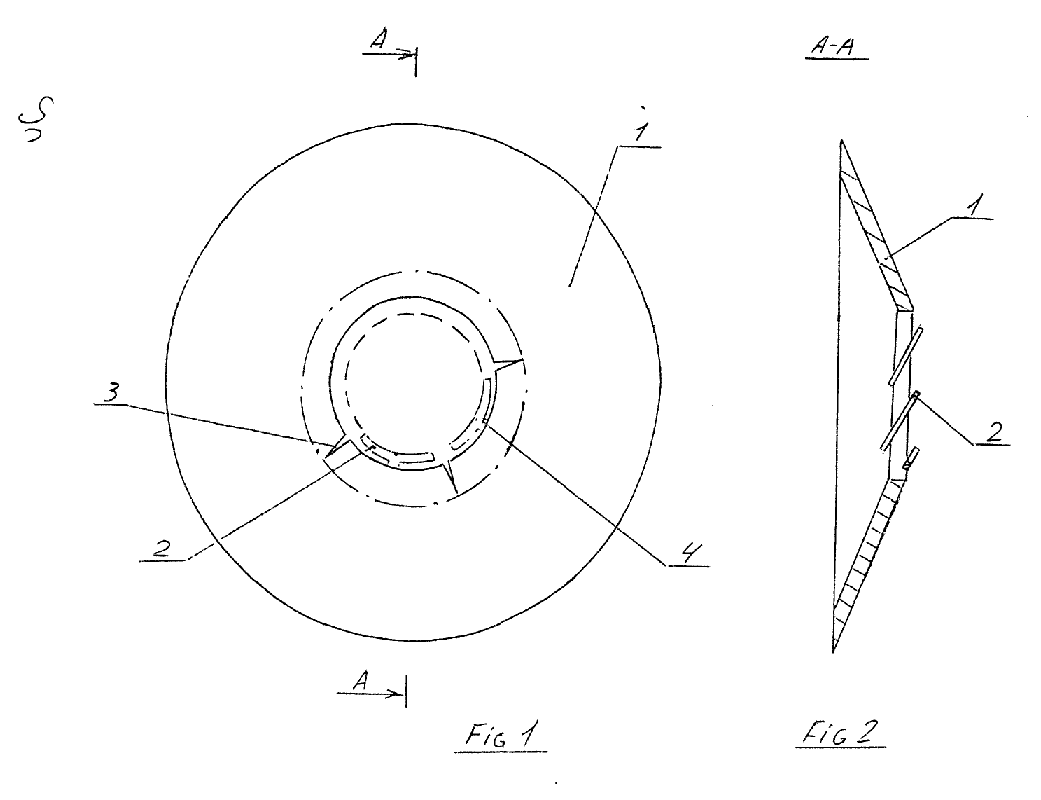

The first embodiment of this invention (FIGS. 1 and 2) consists of a cupped lock-washer (1) made of metal or other suitable material with tooth-like protruding elements (hereinafter tabs) along the perimeter of the central hole. The tabs (2) have curved edges and are also sharpened along these curved edges. The sharpened curved edges of the tabs form a circle of a diameter which is slightly larger by a predetermined amount than the diameter of the threaded part such as the shank of a screw or a bolt so that the said shank can pass through the central hole. The tabs are positioned at an angle relative to the plane of the central hole, to prevent the tab tips from getting into the thread on the said shank prematurely before the lock-washer is flattened, with the ends of the tabs protruding outward beyond the plane of the central hole, To ensure that the central hole narrows readily when this lock washer is compressed during tightening, slits (3) between the tabs along the perimeter of the central hole may be provided.

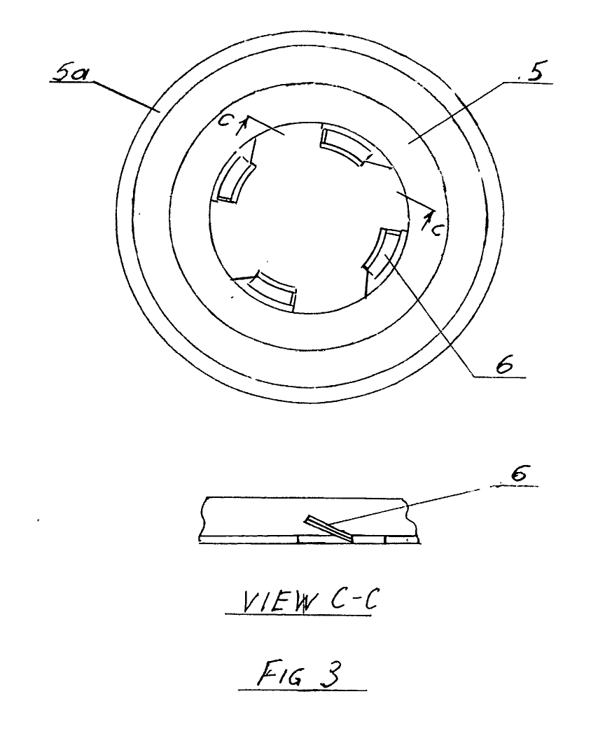

The second embodiment (FIG. 3) is a lock-washer which is ring shaped (5) and the ring cross-section along its perimeter is uniform and semi-circular, but can alternatively be semi-elliptical, upside down “V” shape, with two or more “waves” along the radius or of some other suitable shape. The 3 or more tabs (6) are located along the perimeter of the central hole and their spans are level with its plane, but their surfaces are set at an angle to the plane of the central hole to prevent the tab tips from getting into the thread on the said shank before being flattened. The sharpened and pointed tips of the tabs form a circle of a diameter which is slightly larger than the diameter of the threaded part such as the shank of a screw or of a bolt so that the said shank can pass through the central hole. To ensure that the central hole narrows readily when this lock washer is flattened during tightening, slits (not shown) between the tabs along the perimeter of the central hole may be provided. The flat outer annular area (5a) is for restricting the expansion outward, so as to direct it mostly inward. Also this embodiment can be implemented as a cupped lock-washer.

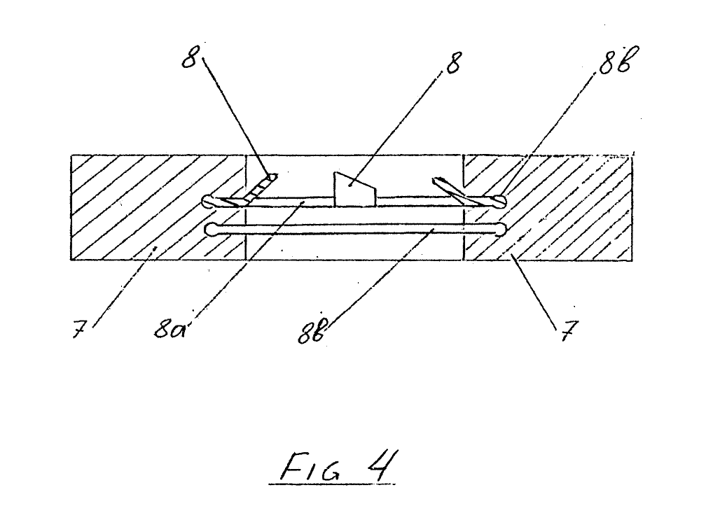

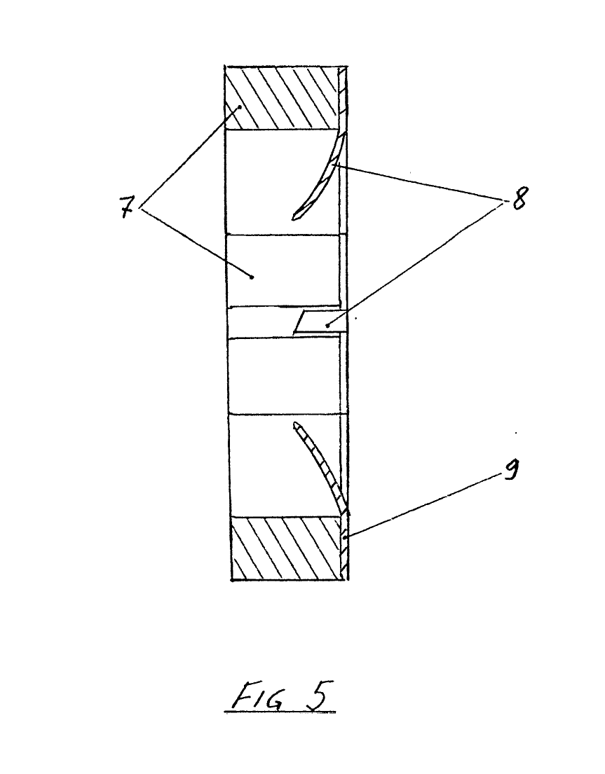

In the third embodiment (FIG. 4a) the lock-washer of this invention for one time use can be made of metal with deformable, compressible structure (7a) along its perimeter. For repeatable use (FIG. 4) the tabs (8) are preferably made of metal and are located on a ring base (8a) similar to a retaining ring, with said ring inserted into a circular groove (8b) on the inside cylindrical surface of elastic ring's (7) central hole. Said elastic ring (7) made of a compressible, elastic material such as for example nylon or vinyl. The tabs are moderately inclined upward either all at the same angle to the plane of central hole or, optionally at an angle corresponding to their location along the thread coil taking into account its pitch. Said ring allows a degree of elastic twisting thereby allowing a tab being pressed by the nut to incline towards the central hole with its tip entering the thread channel. For adjustability of the axial force/torque limit there may be more than one such groove (8b) into which said tab ring base can be inserted. Alternatively for adjustability of said ring base's (8a) position and therefore the adjustability of axial force/torque limit, there may be one continuous helical groove on said inside cylindrical surface suitable for screwing the ring base in either direction. The predetermined tab length and angle of each tab's upward bent will in that case take into account each tab's position along the helical groove as well. For heavier duty applications and repeatable use, second version of the lock-washer of this embodiment (FIG. 5) features a flat base which is made of metal or other suitable material (9) with a central hole and tabs along its perimeter, to base (9) are glued or otherwise affixed by known means a compressible, elastic ring (7) with cut outs over the tabs (8), which could be made of suitable plastic or elastomer. Preferably the tabs will have cut outs on both of their sides extending close enough to the outer edge of the lock-washer and being wide enough to allow the resulting elongated and narrow attachment area of the tab to have an elastic twisting motion of predetermined small angle, which together with the elastic straightening out of the curved tabs is to add up to the small movement of tab's sharp edges into the thread channel being entirely elastic and therefore repeatable. Optionally the tabs can be located on an elastic ring as in the first version of this embodiment (FIG. 4, 8b) and that ring can be mounted by known means onto a flat base with an elastic element affixed to it. The tabs (8) have sharp tips of the same pitch as the thread and bent moderately upward, so that they when pressed by the nut, will straighten out by a predetermined small amount and thus extend radially inward into the thread channel. Optionally a lip along the perimeter of the metal base can be provided to prevent or limit the outward expansion of the compressed elastic material and to keep the compressible ring more securely in place. Third version of this embodiment will be similar to the second version, except the tabs will be set at predetermined angle to the lock-washer's flat base which is suited for the tabs being pushed by a predetermined small distance forward (instead of a nut) by the lateral expansion “flow” under compression of the elastic material comprising said elastic ring with appropriately smaller cut outs for the tabs to ensure the “flow” of material being compressed reaches the tabs. The tabs will have a broadened outline (not shown) where it is in contact with said elastic material to assure that said elastic material does push it slightly forward and doesn't just “flow” around it. Fourth version of this embodiment (FIG. 5A) will have a preferably metal flat base with sharpened tabs along the perimeter of central hole as in the preceding version two and as an elastic compressible element affixed there by known means is a suitable spring washer(s) of known variety such as for example wave washer(s), likely either nested or stacked (9a) or double coil spring washer or a very short coil spring having a few coils or a cup spring.

Optionally for the lock-washers of this embodiment, where there is a need to assure proper centering of the lock-washer relative to the bolt's shank, unsharpened centering tabs (not shown), 3 or more of them, can be provided. They are to be of such length that they either touch or are in close proximity to the bolt shank's thread. If the thickness of said unsharpened tabs is insufficient to prevent their entry into the shank's thread channel, then the tabs are twisted around their spanwise axis to an angle different than said thread's pitch thus assuring their non-penetration into the thread channel.

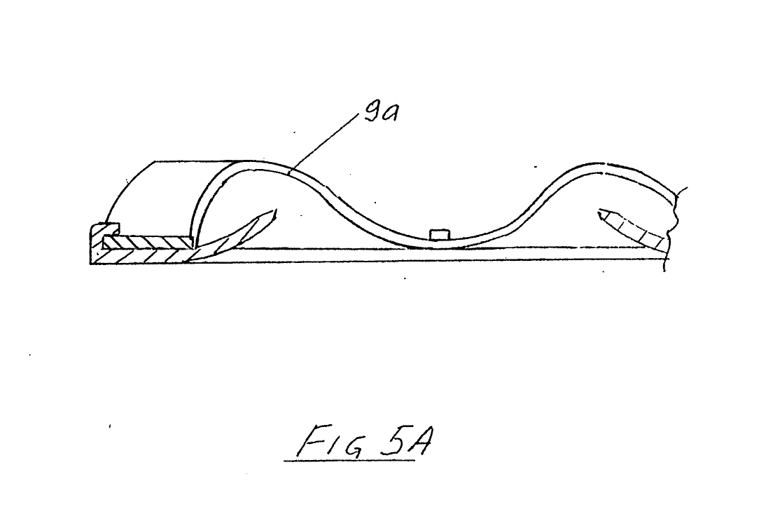

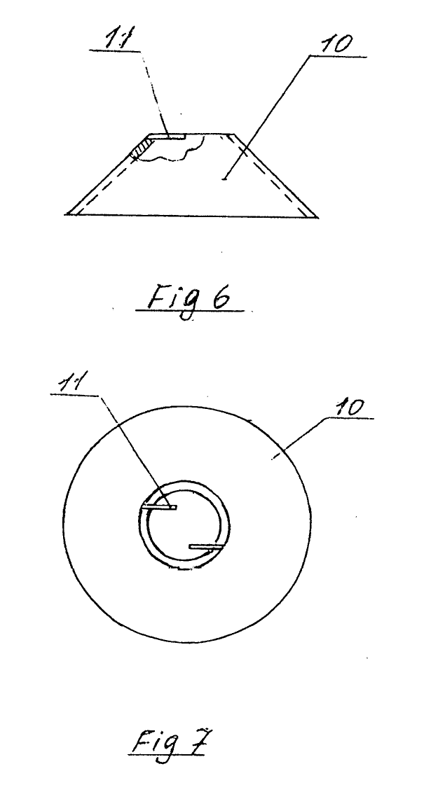

Fourth embodiment of this invention (FIGS. 6 and 7) consists of a cupped lock-washer (10) made of metal, and preferably resilient metal or other resilient material if the repeatable use is intended, with 1 or preferably 2 or more holes for the elastic wires. Said holes can be placed near the central hole or alternatively instead of the holes, slits in the perimeter of the central hole can be used for the purpose of the said wires installation in them (11). Also as another possibility the holes can be placed near the outer edge of the cupped lock-washer or slits in the outer perimeter line of the lock-washer can be used for the said wires installation. Said wires can be flat, round and of other shapes, but have to be sufficiently small in size to fit into the said shank's channel between the adjacent threads and to leave room there for the leading end of the nut's thread to enter the channel and become jammed. The wires should be installed in such a manner that when the lock-washer of the present invention is placed onto the threaded shank of a bolt or a screw it will be possible to move it along into position while the end(s) of the said wire(s) slide ratcheting along said threaded shank or that the washer can be screwed onto the shank. Furthermore the wires should be installed at such an angle and be of such length that once this lock-washer is placed onto the threaded shank, the ends of the wires should be lodged inside the thread channels formed by two adjacent threads, whereas the wires need to be positioned generally tangentially to the cylinder-like threaded shank's surface while being generally perpendicular to its axis. If the cup shape of a lock-washer of this embodiment is no higher than a predetermined maximum height at which elastic compression can be expected, then said lock-washer will be suitable for repeatable use. Second version of this embodiment can be implemented as a compressible ring similar to the second embodiment with the wires either pressed into the slits on the perimeter of the central hole or attached by other known means. Instead of the wires (FIG. 7A) tabs can be used with tangential, to the bolt's threaded shank, part of their tip (11a) protruding towards the side from which the nut thread's leading end is to advance—their stopping action will be similar to that of the wires but this version is easier to manufacture, as no second component is involved.

The fifth embodiment of this invention (FIG. 8) consist of a flat circular metal base with at least 2 and preferably more tabs (12) inclined slightly forward (towards the advancing nut) by a predetermined angle from the plane of the said metal base. The edges of these tabs are located at a radial distance from the central hole's center which is less by a predetermined distance than the radius of the threaded shank that is to be put through the central hole at the time when the threaded connection is assembled, to assure that these tabs enter the channel between the adjacent threads on said shank at the assembly time already. Thus in this embodiment tabs are not moving. On the flat metal base (12a) there is placed or affixed by known means a ring made of elastic compressible material (12b), as in the third embodiment. Alternatively (FIG. 9) the elastic, compressible component will be forming an integral whole with the lock-washer's structure bent into a suitable compressible shape (13). Such elastic compressible component's structure could be similar in shape to wave washer or finger washer. Cuts in the surface (13a) are for allowing broadening movement of the parts of lock-washer that are being flattened. As the tabs are only minimally beyond the plane of the base's flat portion immediately adjacent to the central hole, the wavy shapes can be of relatively low height thus allowing said shapes elastic compression and therefore repeatable use of such lock-washer whereas the lock-washer is relatively thin.

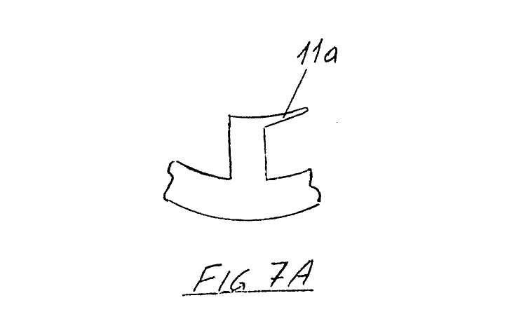

The sixth embodiment of this invention would be especially suitable for threaded connections where a bolt or a screw is used without a nut and intended to make the reaching of the designated level of the axial load in the threaded connection highly noticeable by means of indicative changes in the shape of the lock-washer. One way if implementing this approach is exemplified by this embodiment; a lock-washer (FIG. 10) with a flat base (14) and a number of tabs (15) of the same thickness as the base, evenly spaced along the periphery of the lock-washer's outer edge, at a slight angle to the vertical axis outward. Preferably the inner edges of the tabs will be beveled (16) to assure that a bolt head's edges slide over them smoothly. It is preferable to have the inner surface of the tabs brightly colored or shiny. Optionally a compressible ring, such as made of plastic combining sufficient hardness with elasticity, can be inserted inside the structure of base with tabs (14) for larger designated loads.

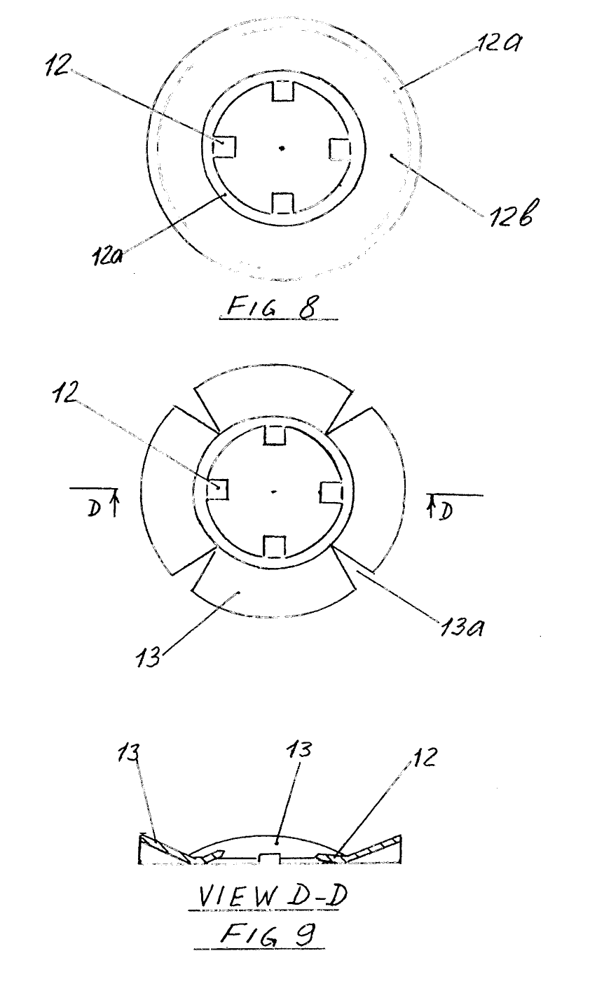

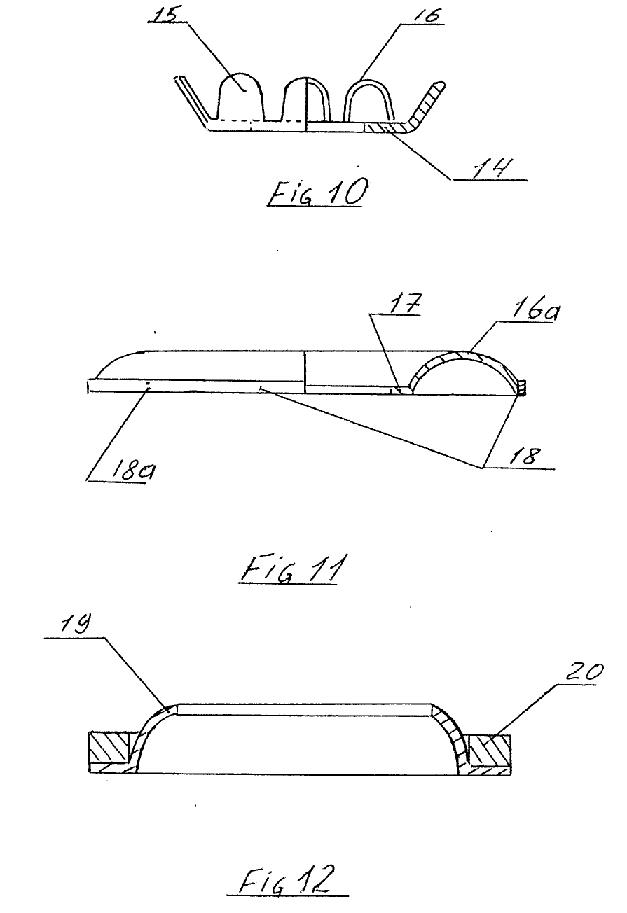

For the seventh embodiment, which is also particularly suitable for threaded connections where a bolt or a screw is used without a nut, a compressible annular lock-washer (FIG. 11) is proposed with arched cross-section (16) and a flat annular inner part (17) to restrict the inward expansion of the washer during compression. Along the outer perimeter of the lock-washer, a plastic or made of other suitable material band, is affixed by means of being glued in a number of pre-determined locations along the perimeter to the body of lock-washer. Said band (18) will have a number of puncture lines (18a) to assure that it breaks in these pre-determined locations when the lock-washer is compressed. The eighth embodiment for light duty applications can be a ring with two flat surfaces on the top and on the bottom with the uniform rectangular cross-section along the perimeter of said ring. This ring is made of a transparent plastic such as vinyl, nylon, polyethylene etc. For heavier duty applications (FIG. 12) an elastic metal structure such as for example a cupped lock-washer (19) is surrounded by a similar to above-described plastic washer ring (20). A type of known piezo-luminescent material, which emits light depending on the pressure applied to it, is on one surface of said washer ring, alternatively it could be on both top and bottom surfaces of said ring (20) or it could be on only one surface and another surface will then have a reflective coating on it such as silvery paint. The ninth embodiment is for decreasing the tightening level in order to be able to easily disassemble a threaded connection, such as for example lug nuts on vehicle wheels, which are routinely overtightened making them very hard to disassemble. The first version of this embodiment (FIG. 13) will feature a flat container washer (21) which is hollow inside and is filled either with fine sand or a suitable flowing non-clump forming powder or miniature, relatively to the size of container washer, balls made of metal or other suitable material. The container washer has a tab (22) for opening it, similarly to such tabs on food and beverage containers. Alternatively the container washer is filled with water or other incompressible liquid, accordingly it needs to be made of materials able to withstand very high inside pressure. For example materials made of, or comprising carbon fiber, kevlar or graphene. It will also require either a suitable outlet which is appropriately capped or has a miniature valve able to withstand very high pressure. Alternatively for one time use container washer, it is made openable by cutting it, preferably in a designated place on its surface. Still another way of implementing the container washer is by filling it with solid when compressed, but easily soluble matter such as a suitable mineral salt, sugar etc. In this case the container washer will be provided with closable water (or other solvent) inlet and outlet. The second version of this embodiment features a washer able to change its thickness outright wherein it comprises a ring made of Smart Memory Alloy (hereinafter SMA) which upon being heated will change its shape, so as to become thinner thereby at once relieving the over-tightening condition and if such thinning is of sufficient degree may untighten the threaded connection without unscrewing it, thus making the nut easily un-screwable. Alternatively such thickness changing washer can be implemented as a container washer with volume or size changing filling such as for example vanadium dioxide which changes its volume upon application or removal of voltage or piezo-electric crystals changing their size upon application or removal of voltage. The filling's volume or pertinent size change will produce corresponding washer thickness change. Still another way of implementing this version of ninth embodiment is to have a washer changing its cross-section's configuration (FIG. 14)—in this example the washer consists of concentric folds (23) that will unfold when pushed by SMA inserts (24) thereby making the washer thinner as it expands radially.

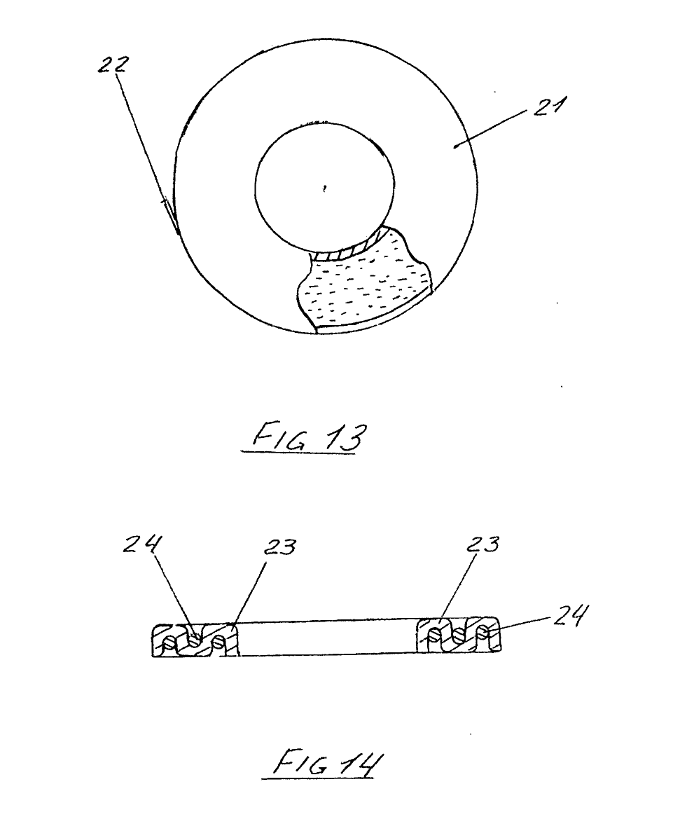

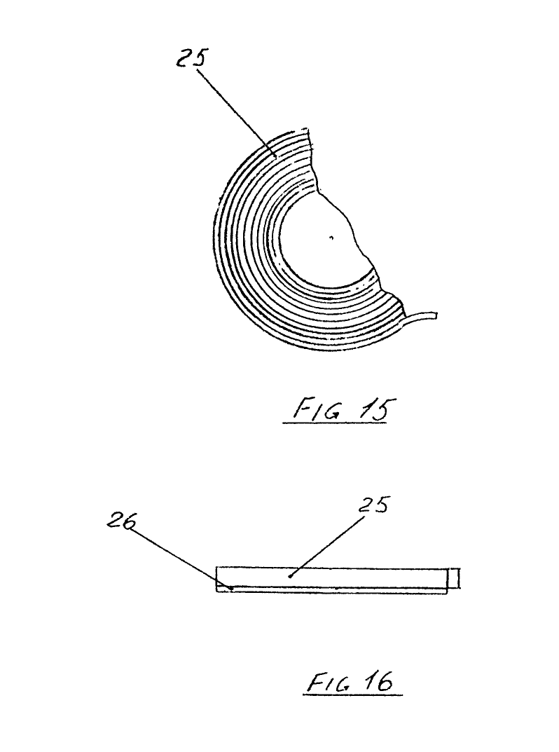

The tenth embodiment provides a washer which is removable from a tightened threaded connection thereby making said connection untightened and therefore very easy to disassemble. Such washer (FIG. 15) consists of a disc-like spiral made of metal or other suitable material thin flexible band (25) which is narrow; generally no more than a few millimeters wide. For non-flat areas around the bolt the spiral can be made of a corresponding shape instead of flat. To assure that said disc-like spiral stays flat and does not disintegrate the coils are wound tightly and may be lightly glued to each other and/or (FIG. 16) said disc spiral is affixed to a thin, relatively to the thickness of said disc, round base plate (26). Optionally said thin, round base plates can be affixed on both; top and bottom surfaces of disc spiral. The side of this spiral washer which is facing the nut will be of height slightly tapering from the outer edge towards the center by a predetermined amount to assure more distribution of pressure towards the outer parts of disc spiral and that the tightening is decreased gradually as the coils are unwound.

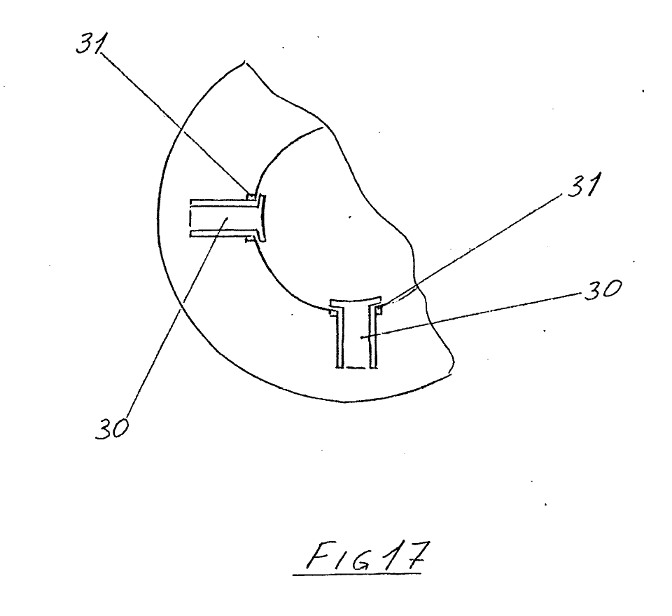

The eleventh embodiment provides solutions for over-tightening in self-tightening power tools and other self-tightening applications. The difference here is that generally it's not the nut which is causing the over-tightening (unless it was over-tightened right at the time of the threaded connection's assembly which is usually not the case for power tools), but rather the turning movements of underlying part such as an abrasive disc during its use. Accordingly the first version of this embodiment (FIG. 17) features a flat washer with at least 2, optionally slightly curving upward, radial tabs with sharp forward edges (30) of predetermined length, which are bent upward at predetermined angles corresponding to their locations along the thread coil taking into account its pitch; so as to enable the screwing of the washer onto power tool's threaded spindle. As the underlying disc or a circular saw turns during operation, it drags along, turning, the washer of this embodiment which causes the tabs embedded into the thread channel to travel along it while unbending and straightening out. As bent and curved tabs fully straighten out, they butt up into the bottom of thread channel strongly pressing on it thereby acting as brakes for the washer of this embodiment and thus also acting as a brake for the nut pressing on the washer and thus preventing its overtightening. Optionally the tabs will have hammer head outline whereas on the two sides of them there will be lips (31). The hammerhead sides will slide down and rest against the lips (31) which will prevent the tabs buckling under the force of pressure that they exert upon the thread channel's bottom. In the second version of this embodiment (FIG. 18) the washer as described for the first version is affixed by known means upon the abrasive disk or circular saw and becomes a part thereof. It will work in operation in the same way as described for the first version of this embodiment. In the third version of this embodiment (FIG. 19) the washer as described for the first version of this embodiment is turnably attached by known means to the nut on the side facing the abrasive disc or circular saw etc. and also works the same way as described for the first version. The attachment of the washer (31a) to the nut may for example comprise attachment struts (32) having lugs inserted into the circular groove on the nut (33) wherein said groove has indentations (33a) for the lugs, to assure that the washer turns with the nut while it is being initially tightened. Once it has been initially tightened the elastic compressible ring (34) in the groove will compress allowing the lugs to come out from the indentations (33a) thus enabling the washer to turn independently of the nut and thereupon to work as described for the first version of this embodiment.

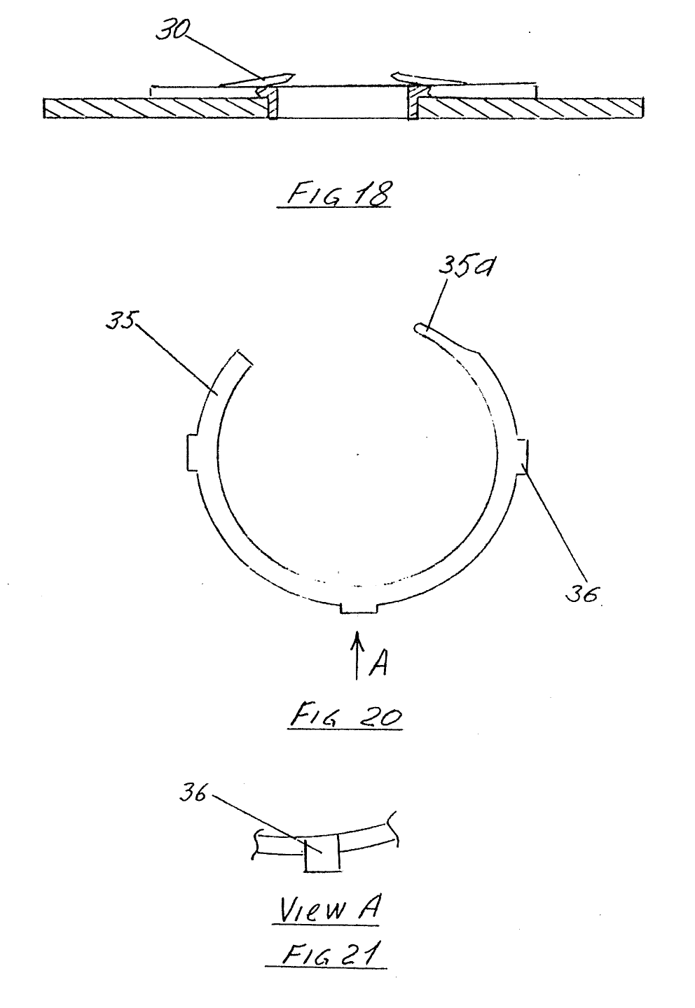

The twelfth embodiment provides another solution for over-tightening in self-tightening power tools and other self-tightening applications. This embodiment consists (FIG. 20 and FIG. 21) of a helically shaped incomplete coil strip (35) which has narrowed ending (35a) and the supports (36) whose length is consistent with their location along said coil (35) taking into account its pitch which corresponds to that of the spindle thread's pitch. Individual supports (36) can be replaced with skirting playing the same support role.

Where appropriate for the embodiments with insertable tabs or wires the thickness of the tabs/wires would preferably be significantly less than half of said pitch length or alternatively the portion of the tabs that would enter the thread needs to be made thinner or be suitably sharpened. It is desirable to have the axial load limit, for which a given lock-washer of this invention is designed, to be stamped or otherwise imprinted on it.

### 5. SKETCHES AND DIAGRAMS

Provided separately.

### 6. OPERATION

For the first embodiment when the shank of a threaded part such as a bolt or a screw is passed through the central hole of this lock-washer the edges of the tabs located along the said hole's perimeter do not get into the thread channel formed by two adjacent thread crests on said shank as tabs are at a significant angle to the hole's plane and also at a significant angle with the said thread channels between its thread crests. When the threaded connection of which a lock-washer of the present invention is a part, is tightened the whole lock-washer is flattening with the tabs being turned at the initial stage of flattening, so that the ends of the tabs protruding beyond the plane of the central hole, align with the central hole's plane and given their length from the pivoting base (4) and distance of said pivoting base from the said plane of central hole are geometrically pre-determined to form an angle with the shank's axis which is generally equal to the angle of its thread with the said axis and thus align with the said thread channel on said shank. During flattening the central hole narrows a predetermined distance causing the tabs, by then aligned with said hole's plane, to enter the thread channel between its thread crests. As the tightening is continuing and the lock-washer flattens a pre-determined distance, the nut will reach the thread lap on the threaded shank where the tabs are lodged and then the nut thread's leading end will attempt to ride over the nearest of said tabs which will cause the thread to jam. Thus no further tightening will be possible and the axial load in the threaded connection will not exceed the pre-determined limit.

For the second embodiment, as the threaded connection is tightened the central hole narrows. When the nut front surface reaches the tabs it begins to align them with the said thread channels on the said threaded shank. As the lock-washer compresses a pre-determined distance, its central hole also narrows a pre-determined distance causing the by then aligned with the thread tabs to enter the said channel. Further tightening will cause the axial load in the threaded connection to reach a pre-determined level and at that point the nut, having traveled a pre-determined distance will encounter the tabs lodged in the thread channel and will become jammed—making further tightening and the increase in the axial load impossible.

For the third embodiment, as the threaded connection is tightened the ring (7) made of compressible material undergoes flattening. As the said ring compresses a pre-determined distance and the advancing nut pushes tabs into the channel between the threads or in another version of this embodiment the compressible material under pressure “flows” radially inward pushing the tabs and causing them to straighten out and thus extend radially inward into the central hole, reaching the threaded shank, entering the said channel between its threads and becoming lodged there. Further tightening will cause the axial load in the threaded connection to reach a pre-determined level and at that point the nut, having traveled a pre-determined distance will encounter the tabs lodged in the thread channel and will become jammed—making further tightening and the increase in the axial load impossible.

For the fourth embodiment when the threaded connection is assembled the lock-washer is put in place by sliding it onto said shank with the elastic wires ratcheting along said shank or screwing it onto the shank. If the elastic wires are located near the narrow end of this cupped lock-washer it will be put against the work part, whereas the opposite, wider side will be pressed on by the nut being tightened. During tightening the narrow part of the cupped lock-washer body will compress first, as the concentration of the compressive stress will be higher there compared to the wider part of the lock-washer's body. That will cause the wires to move inward a predetermined distance and their ends will become lodged in a predetermined position in said thread channel (FIG. 7). Further tightening will cause the axial load in the threaded connection to reach a pre-determined level and at that point the nut, having traveled a pre-determined distance will encounter a wire's end lodged in the thread channel and will become jammed—making further tightening and the increase in the axial load impossible.

For the fifth embodiment when the lock-washer of the present invention, during the time of assembly of the threaded connection, is placed onto the threaded shank of a bolt or a screw. It is possible to move it along into position either by screwing it onto bolt's shank and/or moving the washer from side to side while moving it along the bolt's shank. Thus the tabs will enter the said thread channel at the time of assembly at a slight angle with the plane of the central hole and thus slightly beyond it because the tabs extend radially inward far enough, more than just reaching said channel. Further tightening will cause the axial load in the threaded connection to reach a pre-determined level and then the nut, having traveled a pre-determined distance will encounter the tabs lodged in the thread channel and will become jammed—making further tightening and the increase in the axial load impossible.

The sixth embodiment works as follows; the lock-washer is put onto the shank of a bolt or a screw with tabs facing the nut which is put on said shank after the lock-washer. As the tightening begins the bolt/screw's head does not fully fit into the circle formed by the tabs and as it moves it pushes them to the sides bending them in the direction of its travel. When the bolt/screw's head has traveled a pre-determined distance, the axial load in the threaded connection will reach the designated level, while the tabs will be flattened completely and visibly extended from under the bolt/screw head which will be visible to the worker, especially if their inner surfaces were brightly colored and thus now would provide a visual signal to the worker to stop tightening.

For the seventh embodiment as the tightening proceeds the lock-washer flattens and expands radially outward, being restricted from inward expansion by the flat annular area around the perimeter of the central hole.

Upon reaching the designated axial load the lock-washer will have expanded outward a predetermined radial distance causing the plastic band around it to audibly break in at least one predetermined place. The ends of the ruptured band will peel off in a pre-determined manner—thus both an audible and a visual signal will be provided to the worker to stop tightening.

For the eighth embodiment when the threaded connection is tightened the piezo-luminescent material on at least one surface of the plastic ring will emit light which due to refraction or reflection from the reflective surface will be visible on the side of the plastic ring, signaling to the worker to stop tightening when the light signal is displayed. For heavier duty applications including an elastic metal structure such as the cupped metal washer—that structure will bear most of the load with the plastic ring being compressed only at the final stages of the tightening and then performing as described above.

For the ninth embodiment either container washers are made thinner by releasing their content or the washers using SMA are activated becoming slimmer and thereby leaving the threaded connections untightened and easy to unscrew. These washers are particularly usable for wheel lug nuts or over-tightened power tools which are notoriously difficult to unscrew.

For the tenth embodiment the spiral-disc washers are unwound from under the nut and removed leaving a threaded connection untightened and easy to disassemble, possibly by hand. These washers are particularly usable for wheel lug nuts or rusted and stuck threaded connections which are difficult to unscrew.

For the eleventh embodiment the operation is adequately described in the Description Section and will not be reiterated here but is included by way of reference as if fully set forth.

For the twelfth embodiment the partial coil (35) is to be screwed onto the spindle until its supports (36) butt up against the top of disc centering bushing of round support base underlying the abrasive disc. During operation as the abrasive disk starts turning it drags the spindle nut with it until the leading end of said nut's thread encounters the narrowed ending (35a) in the spindle thread channel and jams thereby stopping any further tightening of the nut. The supports (36) length is predetermined to limit the nut's turning before it seizes and becomes stuck. Clearly, for the abrasive disks of different thicknesses the coil supports (36) need to be of different lengths.

For the embodiments with insertable tabs or wires when the threaded connection needs to be unscrewed the thread will un-jam without undue difficulty, as even the minimal movement in the opposite direction to that of tightening will make smaller the wedging effect of the tab between the threads of the nut and bolt/screw making subsequent unscrewing movement easier still.

### 7. RAMIFICATIONS

These lock-washers can be used to largely eliminate the common problem of thread damage or leveling due to over-tightening, while greatly reducing the need for the complex and expensive torque-limiting or indicating manual and power tools. At the same time it can lead to increased use of power tools when assembling or repairing objects prone to deforming or cracking such as those made of aluminum and other non-ferrous alloys, plastics and wood thus allowing increased productivity. Also these lock-washers will prevent the threaded connections from being unnecessarily tightened beyond the design requirements and that would make unscrewing them easier. Furthermore these lock-washers will provide much better locking action than the prior art lock-washers as in addition to applying the axial force to increase the friction between the two parts of the threaded connection in order to prevent their relative movement and loosening, these lock-washers will also jam the thread. The much improved locking action in turn makes possible using thinner lock-washers and applying lower torque and/or less effort to adequately tighten or unscrew the threaded connections. The washers changing their thickness or being unwound and removed from the threaded connection will allow the easy disassembly of otherwise difficult to undo threaded connections such as for example lug nuts on wheels.

What claimed is:

1. A washer with structural means to produce its predetermined deformation, with said deformation resulting in overtightening prevention or elimination.

2. The washer of claim 1 wherein said structural means to produce its predetermined deformation are means to assure its flattening during tightening, further comprising stopping means along the perimeter of its hole for jamming the nut, whereby further tightening is prevented and the axial load in the threaded connection is limited to a pre-determined level.

3. The washer of claim 2 wherein said structural means to assure flattening are relief parts of the washer's structure.

4. The washer of claim 2 wherein said structural means to assure flattening comprise elastic element suitable for repeatable compression.

5. The washer of claim 3 wherein said stopping means are inclinable towards said threaded shank tabs disposed along the perimeter of washer's central hole for the purpose of entering said shank's thread to jam the nut.

6. The washer of claim 3 wherein said stopping means are tabs movable towards said shank due to central hole narrowing during tightening, with said tabs disposed along the perimeter of washer's central hole for the purpose of entering said shank's thread to jam the nut.

7. The washer of claim 3 wherein said stopping means are wire-type elongated rods disposed generally tangentially to the threaded surface of the shank for the purpose of entering said shank's thread to jam the nut.

8. The washer of claim 4 wherein said stopping means are inclinable towards said threaded shank tabs disposed along the perimeter of washer's central hole for the purpose of entering said shank's thread to jam the nut.

9. The washer of claim 4 wherein said stopping means are wire-type elongated rods disposed generally tangentially to the threaded surface of the shank for the purpose of entering said shank's thread to jam the nut.

10. The washer of claim 8 where said tabs are affixed to a ring which is placed into a groove means of said elastic element.

11. The washer of claim 10 where said groove means in the elastic element is at least one circular groove in the central hole of said elastic element.

12. The washer of claim 11 where said groove means in the elastic element is at least one helical groove in the central hole of said elastic element.

13. The washer of claim 3 wherein said stopping means are tabs disposed along the perimeter of washer's central hole for the purpose of screwing the washer onto said shank's thread by means of entering said tabs into the shanks thread wherein they are to jam the nut.

14. The washer of claim 4 wherein said stopping means are tabs disposed along the perimeter of washer's central hole for the purpose of screwing the washer onto said shank's thread by means of entering said tabs into the shanks thread wherein they are to jam the nut.

15. The washer of claim 1 wherein structural means to assure its deformation are structural means to assure its flattening during tightening, further comprising indicator means which provide a detectable signal when the lock-washer's deformation and a corresponding axial load in the threaded connection reach the designated level, thereby preventing overtightening.

16. The washer of claim 15 wherein said indicator means come from a group comprising; highly visible washer parts extending radially upon reaching the designated level of tightening, emission of light by piezo-luminiscent layer upon reaching the designated level of tightening and audible and visible rupture of a band placed around the washer perimeter upon reaching the designated level of tightening.

17. The washer of claim 1 wherein the structural means to produce its predetermined deformation are the means to enable the washer to become thinner, whereby the overtightened condition is relieved.

18. The washer of claim 17 wherein the means to enable the washer to become thinner come from a group comprising; washer is a compressible hollow ring with incompressible filling which is can be released, washer comprises smart memory alloy component whose thickness is variable, washer comprises tape wound as a disk spiral which can be unwound partially or fully.

19. A method for limiting the axial load in a threaded connections to a pre-determined level comprising the steps of:
providing the components of a threaded connection including work parts, with suitable openings, which are to be held by the said connection, a nut, an elongated part with a threaded shank of the diameter corresponding to that of the nut and an axial load limiting lock-washer of the present invention with a hole along the perimeter of which are tabs;
assembling the threaded connection by means of passing the said threaded shank through the said openings of the said work parts with the said lock-washer placed on the said shank and screwing the nut onto the said threaded shank;
tightening the threaded connection until the said lock-washer compresses, at which point the tabs enter the channel between the thread crests on said shank
completing tightening the threaded connection when the nut runs into a tab, jams and can't be tightened further limiting the axial load to a pre-determined level.
